(19) United States
(12) Patent Application Publication
(10) Pub. No.: US 2025/0113323 A1
(43) Pub. Date: Apr. 3, 2025

(54) INTELLIGENT SELECTIVE SYSTEM INFORMATION TRANSMISSION DURING MOBILITY

(71) Applicant: T-Mobile USA, Inc., Bellevue, WA (US)

(72) Inventors: Kun LU, Bellevue, WA (US); Jun Liu, Sammamish, WA (US); Egil Gronstad, Encinitas, CA (US); Scott F. Migaldi, Cary, IL (US); John J. Humbert, Roeland Park, KS (US); Karri M. Kuoppamaki, Redmond, WA (US)

(21) Appl. No.: 18/479,763

(22) Filed: Oct. 2, 2023

(51) Int. Cl. H04W 60/04; H04W 36/00

(52) U.S. Cl. CPC H04W 60/04; H04W 36/0061; H04W 36/008357

(57) ABSTRACT

Solutions are disclosed that perform intelligent select whether to transmit a system information block 1 (SIB1) message to a user equipment (UE) during a handover. The wireless network determines whether the UE will be moving to a target basestation having a different tracking area code (TAC) than the source basestation. If so, the source basestation sends the SIB1 for the target basestation to the UE with the handover command, so that the UE is alerted to perform a mobility registration update (MRU) with the new TAC. However, if the UE will be moving to a target basestation having the same TAC as the source basestation, the source basestation sends the handover command without the SIB1 for the target basestation, to save network bandwidth. In some examples, the source basestation queries the target basestation to learn the TAC of the target basestation.

### BACKGROUND

In a fifth generation (5G) standalone (SA) wireless network (cellular network), a mobility procedure is triggered when a user equipment (UE) changes cells. Typically, this begins with a measurement report, after some configured mobility event such as an Event A3 (i.e., a neighbor cell is better than the serving cell by an offset), or an Event A2 (i.e., the serving cell signal falls below a threshold). The wireless network instructs the UE to move from one cell to another cell, either at the same frequency layer or a different frequency layer, with a handover (HO) command. The HO command normally comes to the UE through a radio resource control (RRC) reconfiguration message that contains the radio parameters the UE needs to connect to the target cell (i.e., the new cell to which the UE is being handed over).

However, a tracking area code (TAC) is not included in traditional RRC reconfiguration messages. The expected process is for the UE to obtain the new TAC from the target cell's system information block 1 (SIB1), which is broadcast regularly in each cell, typically every 40 milliseconds (ms) in some wireless networks. The SIB1 carries the most critical information required for the UE to access the cell, such as random access parameters. The SIB1 includes information regarding the availability and scheduling of other system information block (SIBs), such as the mapping of SIBs to system information (SI) messages, periodicity, SI-window size, and other information, in addition to the TAC. As used herein TAC should not be confused with type allocation code or phone number area code, both of which are identified with UEs.

### SUMMARY

The following summary is provided to illustrate examples disclosed herein, but is not meant to limit all examples to any particular configuration or sequence of operations.

Solutions are disclosed that perform intelligently selective system information transmission during mobility. Examples include: determining, by a wireless network, that a first handover from a first base station to a second base station is pending for a user equipment (UE), wherein the first base station has a first tracking area code (TAC) and the second base station has a second TAC that is different than the first TAC; determining that the first base station and the second base station have different TACs; based on at least determining that the first base station and the second base station have different TACs, transmitting, by the first base station, to the UE, a first handover command with a system information block 1 (SIB1) message for the second base station, the SIB1 message for the second base station containing the second TAC; determining that a second handover from the second base station to a third base station is pending by for the UE, wherein the third base station has the second TAC; determining that the second base station and the third base station have a common TAC; and based on at least determining that the second base station and the third base station have a common TAC, transmitting, by the second base station, to the UE, a second handover command and not transmitting, by the second base station, to the UE, a SIB1 message for the third base station.

### BRIEF DESCRIPTION OF THE DRAWINGS

The disclosed examples are described below with reference to the accompanying drawing figures listed below, wherein:

FIG. 1 illustrates an exemplary architecture that advantageously selects when to transmit certain system information during handovers;

FIG. 2 illustrates further detail for the example architecture of FIG. 1;

FIG. 3 illustrates a flowchart for a decision algorithm employed in examples of the architecture of FIG. 1;

FIG. 4 illustrates a flowchart showing the application of the algorithm shown in FIG. 3 applied to the scenario of FIG. 1;

FIG. 5 illustrates a timeline of events identified in the flowchart of FIG. 3 and FIG. 4

FIG. 6 illustrates a flowchart of exemplary operations associated with the architecture of FIG. 1; and

FIG. 7 illustrates a block diagram of a computing device suitable for implementing various aspects of the disclosure.

Corresponding reference characters indicate corresponding parts throughout the drawings. References made throughout this disclosure. relating to specific examples, are provided for illustrative purposes, and are not meant to limit all implementations or to be interpreted as excluding the existence of additional implementations that also incorporate the recited features.

### DETAILED DESCRIPTION

A tracking area identifier (TAI) is a concatenation of a public land mobile network (PLMN) identifier (ID) and a tracking area code (TAC). A PMLN is a concatenation of a mobile country code (MCC) and a mobile network code (MNC). A TAC is the unique code that each cellular operator assigns to each of its tracking areas (TAs). A TA defines a set of cells used for paging a user equipment (UE). That is, rather than paging a UE using every cell in a wireless network, the wireless network selects one or more TACs, based on the UE's most recent registration, and pages the UE using only the cells having the selected TAC(s). A cell site may have one or more cells, and each cell at a cell site typically shares the same TAC. In some examples, a set of a hundred or more cell sites, some of which host more than just a single cell, may share a common TAC.

When a UE changes its serving cell, and the new serving cell has the same TAC as the prior serving cell, there may be no critical need for the UE to perform a mobility registration update (MRU) in a fifth generation (5G) wireless network. The fourth generation (4G) equivalent of MRU is a TAC update (TAU). However, if the new serving cell has a different TAC, the UE should perform an MRU or TAU using non-access stratum (NAS) signaling. NAS is a functional layer in the wireless telecom protocol stacks between UEs and the core network. If the UE does not perform an MRU or TAU, the core network (of the wireless network) will not know the TAC of the cell serving the UE. This will interfere with the wireless network's ability to page the UE, for example to provide a wireless emergency alert (WEA) message or other system information update, and result in an out-of-date registration. The core network may then release the UE context and any ongoing internet protocol (IP) multimedia subsystem (IMS) call may be dropped.

Currently, the TAC is only included in an system information block 1 (SIB1) for a cell, and there are scenarios in which UEs should parse a new serving cell's SIB1 to identify a TAC change but—for reasons out of the control of wireless network operators—do not do so. In such scenarios, calls such as voice over new radio (VoNR) calls (in 5G standalone (SA)) and voice over long term evolution (VOLTE) calls (in 4G) may be dropped. To preclude voice call drops in 5G SA, some networks transmit a dedicated SIB1 message during SA handover using signaling resources. This process sends a dedicated SIB1 message to each UE during each handover, no matter whether it is an intra-TAC handover (same TAC) or an inter-TAC handover (different TAC). This reduces the likelihood that the UE will not be alerted to a change in the TAC, reducing dropped calls.

However, the dedicated SIB1 messages are relatively large. Since they are sent to each UE through an expanded Radio Resource Control (RRC) Reconfiguration message (one-to-one), rather than through broadcasting (one-to-many), and for each handover, this approach inefficiently burdens signaling resources. To prevent inefficient waste of resources, new functionality is introduce herein to identify whether a handover moves a UE to a target cell with a different TAC than the prior-serving cell. A dedicated SIB1 message is sent to the UE only when the TAC is different, but is withheld if the TAC is not different. Based on the average number of cells sharing a given TAC exceeding one hundred for some wireless networks, this novel approach significantly reduces network traffic by dropping the number of times that the SIB1 is transmitted over signaling resources to a mere fraction of its current value.

Solutions are disclosed that perform intelligent select whether to transmit a SIB1 message to a UE during a handover. The wireless network determines whether the UE will be moving to a target base station having a different TAC than the source base station. If so, the source base station sends the SIB1 for the target base station to the UE with the handover command, so that the UE is alerted to perform an MRU or a TAU with the new TAC. However, if the UE will be moving to a target base station having the same TAC as the source base station, the source base station sends the handover command without the SIB1 for the target base station, to save network bandwidth. In some examples, the source base station queries the target base station to learn the TAC of the target base station.

Aspects of the disclosure improve the efficiency of cellular networks without negatively impacting reliability, by reducing traffic that has been determined to be unnecessary. The result is that, with improved efficiency, RRC Signaling load may be reduced significantly. These advantageous results are accomplished, at least in part by, based on at least determining that a source base station and a target base station have a common TAC, transmitting, by the source base station, to a UE, a handover command and not transmitting, by the source base station, to the UE, a SIB1 message for the target base station.

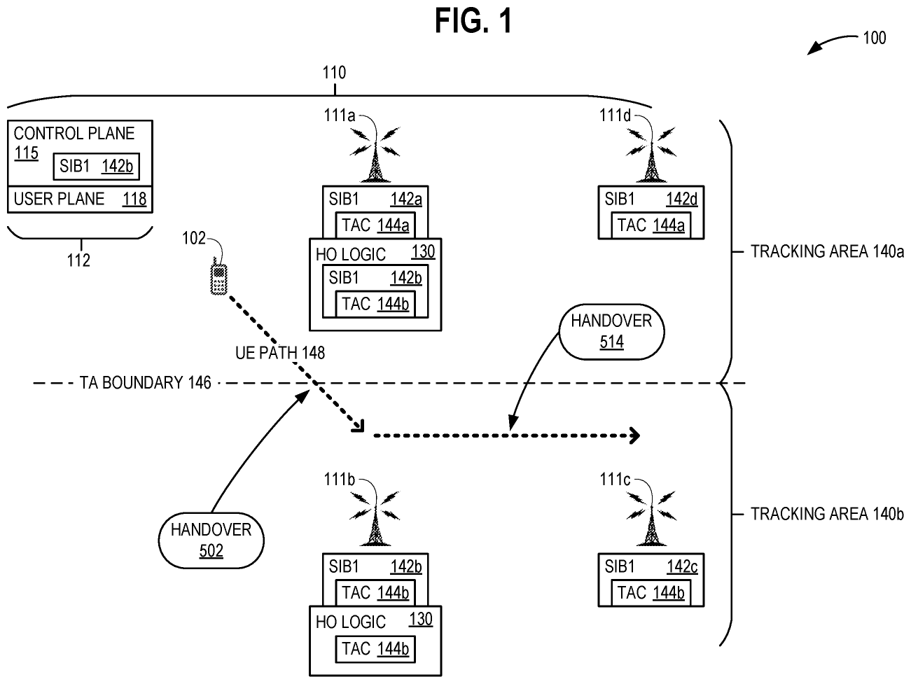

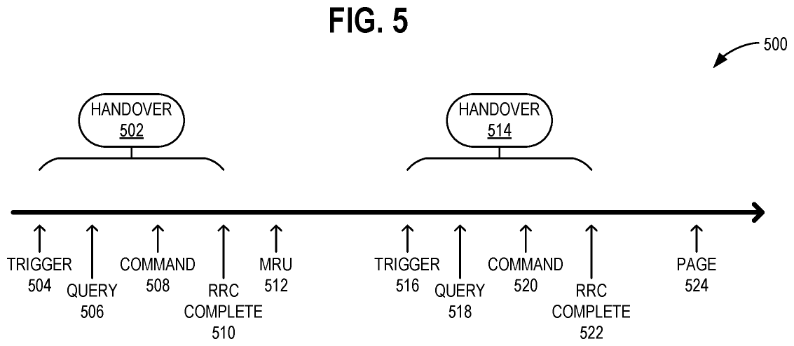

With reference now to the figures, FIG. 1 illustrates an exemplary architecture 100 that advantageously selects when to transmit SIB1 messages during handovers. A wireless network 110 is illustrated with two TAs 140a and 140b, separated by a TA boundary 146. TA 140a has two base stations 111a and 111d and TA 140b has two base stations 111b and 111c, each of which supports at least one cell of wireless network 110. A UE 102, which is using wireless network 110, has a mobility path 148 that takes UE 102 from TA 140a to TA 140b, with a handover 502 moving UE 102 from base station 111a to base station 111b, and another handover 514 moving UE 102 from base station 111b to base station 111c. Handovers 502 and 514 are events that are shown in further detail in FIG. 5.

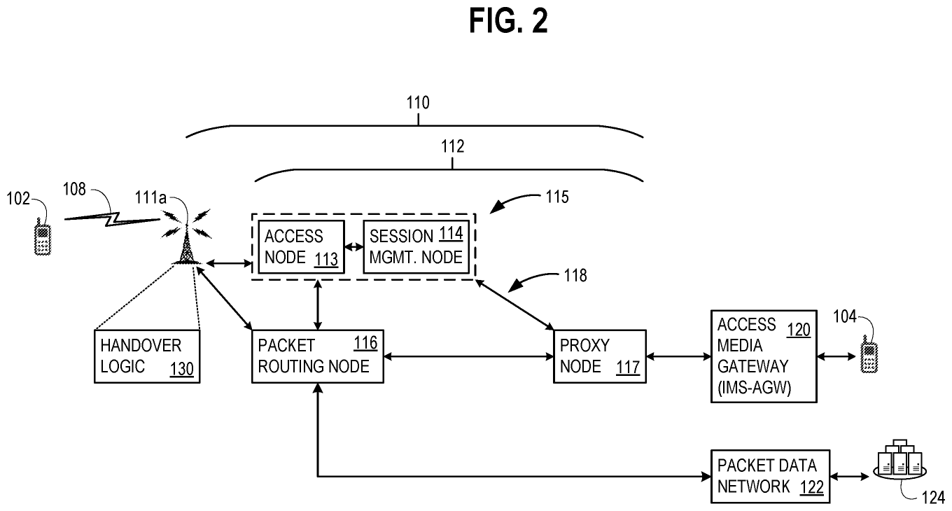

Turning briefly to FIG. 2, further detail is provided for wireless network 110. In the scene depicted in FIG. 2, UE 102 is using wireless network 110 for a phone call to another UE 104 or to reach a network resource 124 (e.g., a website) for a packet data session. UE 102 may be a cellular telephone, such as a smartphone, but may also represent other telecommunication devices capable of using a wireless network, such as a personal computer (PC, e.g., desktop, notebook, tablet, etc.) with a cellular modem.

Wireless network 110 may be a cellular network such as a 5G network, a 4G network, or another cellular generation network. In normal cellular operation, UE 102 uses an air interface 108 to communicate with base station 111a of wireless network 110. In some scenarios, base station 111a may also be referred to as a radio access network (RAN). Wireless network 110 has a core network 112 comprising an access node 113, a session management node 114, and other components (not shown). Wireless network 110 also has a packet routing node 116 and a proxy node 117. Access node 113 and session management node 114 are within a control plane 115 of wireless network 110, and packet routing node 116 is within a user plane 118 of wireless network 110).

Base station 111a is in communication with access node 113 and packet routing node 116. Access node 113 is in communication with session management node 114. Packet routing node 116 is in communication with session management node 114, proxy node 117, and an external packet data network 122, such as the internet. In some 5G examples, base stations 111a comprises a gNodeB (gNB), access node 113 comprises an access mobility function (AMF), session management node 114 comprises a session management function (SMF), and packet routing node 116 comprises a user plane function (UPF).

In some 4G examples, base station 111a comprises an eNodeB (eNB), access node 113 comprises a mobility management entity (MME), session management node 114 comprises a system architecture evolution gateway (SAEGW) control plane (SAEGW-C), and packet routing node 116 comprises an SAEGW-user plane (SAEGW-U). In some examples, proxy node 117 comprises a proxy call session control function (P-CSCF) in both 4G and 5G.

In some examples, wireless network 110 has multiple ones of each of the components illustrated, in addition to other components and other connectivity among the illustrated components. In some examples, wireless network 110 has components of multiple cellular technologies operating in parallel in order to provide service to UEs of different cellular generations. For example, base stations 111b-111d may each comprises a gNB or eNB, and may use different access nodes 113. In some examples, multiple cells may be co-located at a common cell site, and may be a mix of 5G and 4G.

Proxy node 117 is in communication with an internet protocol (IP) multimedia system (IMS) access gateway (IMS-AGW) 120 within an IMS, in order to provide connectivity to other wireless (cellular) networks, for a call with UE 104, or a public switched telephone system (PSTN, also known as plain old telephone system, POTS). In some examples, proxy node 117 may be considered to be within the IMS. UE 102 reaches network resource 124 using either packet data network 122 or IMS-AGW 120. Data packets from UE 102 pass through at least base station 111a and packet routing node 116 on their way to external packet data network 122 or IMS-AGW 120 (via proxy node 117).

Returning to FIG. 1, base station 111a is shown as having compiled its SIB1 142a for broadcast. Base station 111a broadcasts SIB1 142a on a schedule on a broadcast channel, and SIB1 142a includes the TAC for base station 111a, which is a TAC 144a of TA 140a. Base station 111a has a handover logic 130, which is used for computational and messaging tasks for handovers (HOs). For reasons described below, handover logic 130 in base station 111a is shown as having generated a SIB1 142b, which is the SIB1 for base station 111b, and includes the TAC for base station 111b, which is a TAC 144b of TA 140b. In some examples, control plane 115 generates SIB1 142b and sends it to base station 111a for use, as described below.

Similarly, base station 111b broadcasts its SIB1 142b on a schedule on a broadcast channel. SIB1 142b includes TAC 144b of TA 140b, because base station 142b is within TA 140b. Base station 111b also has its own version of handover logic 130, which is shown with a copy of TAC 144b that had been retrieved from base station 111b.

Base station 111c broadcasts its SIB1 142c on a schedule on a broadcast channel. SIB1 142c includes TAC 144b of TA 140b, because base station 142c is within TA 140b. Base station 111d broadcasts its SIB1 142d on a schedule on a broadcast channel. SIB1 142d includes TAC 144a of TA 140a, because base station 142d is within TA 140a. Base stations 111c and 111d each also has its own version of handover logic 130 (not shown).

Mobility path 148 that takes UE 102 from TA 140a to TA 140b, with a handover 502 moving UE 102 from base station 111a to base station 111b, and another handover 514 moving UE 102 from base station 111b to base station 111c. Handovers 502 and 514 are events that are shown in further detail in FIG. 5.

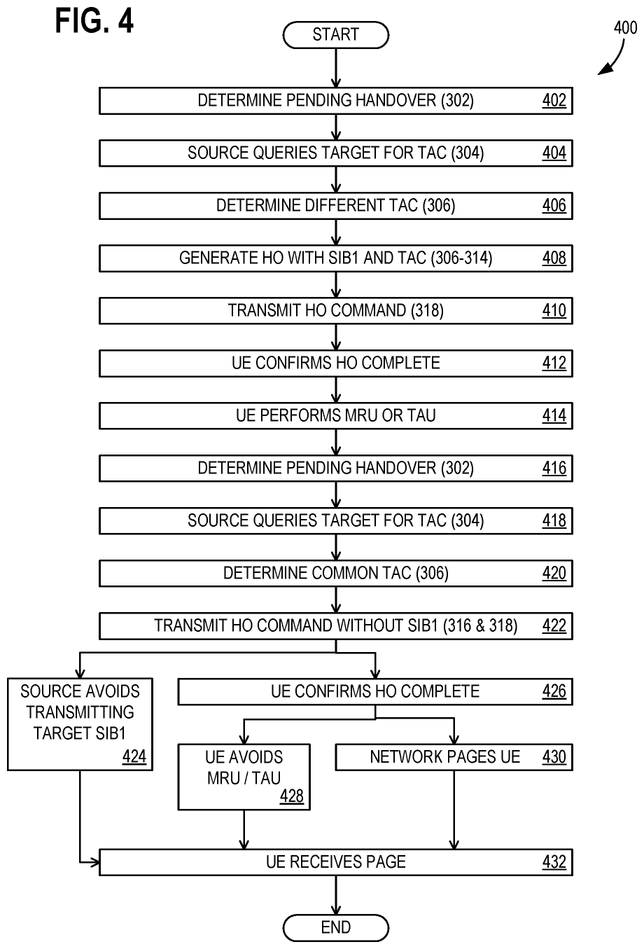

As UE 102 traverses along mobility path 148, it starts from being served by base station 111a, handover 502 moves UE 102 to service by base station 111b, and as UE continues along mobility path 148, another handover 514 moves UE 102 to service by base station 111c. The various events are shown in FIGS. 4 and 5.

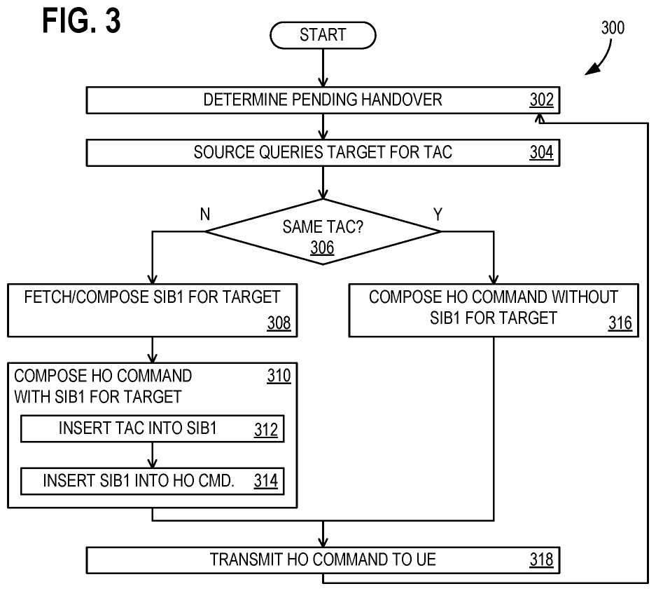

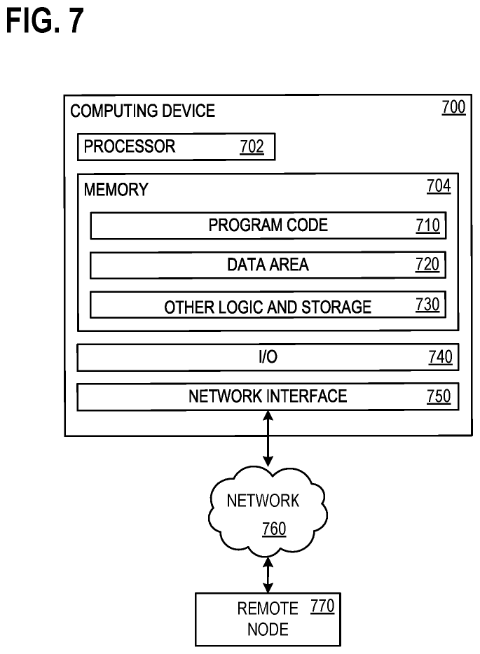

FIG. 3 illustrates a flowchart 300 for a decision algorithm employed by handover logic 130 in each of base stations 111a-111d. In some examples, at least a portion of flowchart 300 may be performed using one or more computing devices 700 of FIG. 7. Flowchart 300 is described for the generic logic, using source base station and target base station. A source base station is the base station that is serving a UE prior to a handover, and a target base station is the base station to which the UE is being moved in a handover.

In the scenario depicted in FIG. 1, base stations 111a and 111b each assume the role of source base station at different times, and base stations 111b and 111c each assume the role of target base station at different times. Base station 111b takes on the roles of both source base station and target base station at different times. The specific application of the logic represented by flowchart 300 to mobility path 148 of UE 102 is shown in FIG. 4, and described below.

Flowchart 300 commences with wireless network 110 (e.g., one of base stations 111a-111d) determining that a handover is pending, in operation 302. In operation 304, the source base station queries the target base station for its TAC. In decision operation 306, the source base station determines whether the target base station has the same TAC. In some examples, another part of wireless network 110 (e.g., control plane 115) performs this task.

If the TACs are different, the handover will be an inter-TA handover, and the source base station generates the SIB1 for the target base station. In some examples, this is accomplished by the source base station requesting the SIB1 for the target base station from control plane 115. See FIG. 1, in which control plane has a copy of SIB1 142, which is the SIB1 for base station 111b, for transmittal to base station 111a, when base station 111a is the source base station and base station 111b is the target base station.

Operation 310 composes the handover command with the SIB1 (including the TAC) for the target base station, and is performed using operations 312 and 314. Operation 312 inserts the TAC into the SIB1, and operation 314 inserts the SIB1 into the handover command.

If the TACs are the same, the handover will be an intra-TA handover, and the source base station will not send the SIB1 over a signaling channel to the UE. Rather, in operation 316, the source base station composes the handover command without the SIB1 or the TAC of the target base station. In operation 318, the source base station transmits the handover command to UE 102. In some examples, the handover command (e.g., handover commands 508 and 520 of FIG. 5) comprises an RRC reconfiguration message, such as RRCConnectionReconfiguration.

FIG. 4 illustrates a flowchart 400 showing the application of the algorithm, shown in flowchart 300 of FIG. 3, applied to the scenario of FIG. 1 in which UE 102 traverses along mobility path 148. In some examples, at least a portion of flowchart 400 may be performed using one or more computing devices 700 of FIG. 7. FIG. 5 illustrates a timeline 500 of events identified in flowchart 400 of FIG. 4. FIGS. 4 and 5 are described together.

Flowchart 400 commences with wireless network 110 determining that handover 502 from base station 111a to base station 111b is pending for UE 102, in operation 402. This determination may be made in base station 111a and/or control plane 115 of wireless network 110. Operation 402 corresponds to operation 302 of flowchart 300 (of FIG. 3), when base station 111a is the source base station and base station 111b is the target base station. Handover 502 is shown on timeline 500 in FIG. 5 as being triggered by a handover trigger 504, and spanning several events.

In operation 404, base station 111a queries base station 111b for the TAC of base station 111b using a query 506. Base station 111b responds with TAC 144b. This corresponds to operation 304 of flowchart 300. In some examples, base station 111a queries control plane 115, instead of wireless network 110, for TAC 144b of base station 111b. In operation 406, handover logic 130 in base station 111a (or located elsewhere in wireless network 110, in some examples) determines that base station 111a and base station 111b have different TACs. This corresponds to the “No” decision of decision operation 306 of flowchart 300.

Operation 408 generates handover command 508 (of FIG. 5), which includes SIB1 142b, the SIB1 for base station 111b. In some examples, control plane 115 generates some or all of SIB1. SIB1 142b includes TAC 144b. Operation 408 corresponds to operations 308-314 of flowchart 300. In operation 410, base station 111a transmits handover command 508 with SIB1 142a (the SIB1 message for base station 111b) to UE 102, based on at least determining that base station 111a and base station 111b have different TACs. This corresponds to operation 318 of flowchart 300.

In operation 412, UE 102 transmits RRC reconfiguration complete message 510 to base station 111b, signaling completion of handover 502. In some examples, RRC reconfiguration complete message 510 comprises RRCReconfigurationComplete. While UE 102 is being served by base station 111b, UE 102 performs an MRU 512 (or a TAU) with wireless network 110, update the registration of UE 102 with second TAC 144b, in operation 414. Wireless network 110 (specifically control plane 115) now knows where to page UE 102 (i.e., which TAC to use for paging UE 102). An intra-TA handover to base station 111c will not change this.

Continuing the traversal of UE 102 along mobility path 148, wireless network 110 determines that handover 514 from base station 111b to base station 111c is pending for UE 102, in operation 416. This determination may be made in base station 111b and/or control plane 115 of wireless network 110. Operation 416 corresponds to operation 302 of flowchart 300, when base station 111b is the source base station and base station 111c is the target base station. Handover 514 is shown on timeline 500 in FIG. 5 as being triggered by a handover trigger 516, and spanning several events.

In operation 418, base station 111b queries base station 111c for the TAC of base station 111c using a query 518. Base station 111c responds with TAC 144b. This corresponds to operation 304 of flowchart 300. In some examples, base station 111b queries control plane 115, instead of wireless network 110, for TAC 144b of base station 111c. In operation 420, handover logic 130 in base station 111a (or located elsewhere in wireless network 110, in some examples) determines that base station 111b and base station 111c have a common TAC (the same TAC). This corresponds to the “Yes” decision of decision operation 306 of flowchart 300.

In operation 422, based on at least determining that base station 111b and base station 111c have a common TAC, base station 111b transmits handover command 520 to UE 102. This corresponds to operations 316 and 318 of flowchart 300. However, base station 111b does not transmit SIB1 142c for base station 111c to UE 102. This negative limitation is shown as operation 424, and endures for the entire time that base station 111c serves UE 102.

In operation 426, UE 102 transmits RRC reconfiguration complete message 522 to base station 111c, signaling completion of handover 514. In some examples, RRC reconfiguration complete message 522 comprises RRCReconfigurationComplete. While UE 102 is being served by base station 111c, UE 102 avoids performing an MRU or a TAU with wireless network 110, because wireless network 110 already knows where to page UE 102 (i.e., which TAC to use for paging UE 102), and the intra-TA handover from base station 111b to base station 111c did not change this. This further saves bandwidth, and this negative limitation is shown as operation 428.

In operation 430, while UE 102 is being served by base station 111c, wireless network 110 pages UE 102 with paging message 524, using TAC 144b. UE 102 receives the paging (paging message 524) from wireless network 110 through base station 111c in operation 432, despite not performing an MRU or TAU after handover 514.

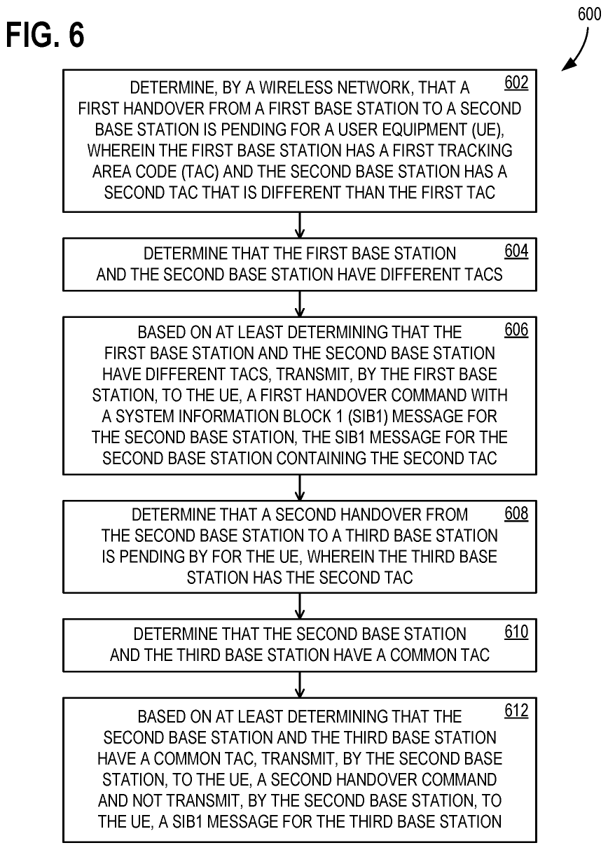

FIG. 6 illustrates a flowchart 600 of exemplary operations associated with examples of architecture 100. In some examples, at least a portion of flowchart 600 may be performed using one or more computing devices 700 of FIG. 7. Flowchart 600 commences with operation 602, which includes determining, by a wireless network, that a first handover from a first base station to a second base station is pending for a UE, wherein the first base station has a first TAC and the second base station has a second TAC that is different than the first TAC.

Operation 604 includes determining that the first base station and the second base station have different TACs. Operation 606 includes, based on at least determining that the first base station and the second base station have different TACs, transmitting, by the first base station, to the UE, a first handover command with an SIB1 message for the second base station, the SIB1 message for the second base station containing the second TAC.

Operation 608 includes determining that a second handover from the second base station to a third base station is pending by for the UE, wherein the third base station has the second TAC. Operation 610 includes determining that the second base station and the third base station have a common TAC. Operation 612 includes, based on at least determining that the second base station and the third base station have a common TAC, transmitting, by the second base station, to the UE, a second handover command and not transmitting, by the second base station, to the UE, a SIB1 message for the third base station.

FIG. 7 illustrates a block diagram of computing device 700 that may be used as any component described herein that may require computational or storage capacity. Computing device 700 has at least a processor 702 and a memory 704 that holds program code 710, data area 720, and other logic and storage 730. Memory 704 is any device allowing information, such as computer executable instructions and/or other data, to be stored and retrieved. For example, memory 704 may include one or more random access memory (RAM) modules, flash memory modules, hard disks, solid-state disks, persistent memory devices, and/or optical disks. Program code 710 comprises computer executable instructions and computer executable components including instructions used to perform operations described herein. Data area 720 holds data used to perform operations described herein. Memory 704 also includes other logic and storage 730 that performs or facilitates other functions disclosed herein or otherwise required of computing device 700. An input/output (I/O) component 740 facilitates receiving input from users and other devices and generating displays for users and outputs for other devices. A network interface 750 permits communication over external network 760 with a remote node 770, which may represent another implementation of computing device 700. For example, a remote node 770 may represent another of the above-noted nodes within architecture 100.

### Additional Examples

An example system comprises: a processor; and a computer-readable medium storing instructions that are operative upon execution by the processor to: determine, by a wireless network, that a first handover from a first base station to a second base station is pending for a UE, wherein the first base station has a first TAC and the second base station has a second TAC that is different than the first TAC; determine that the first base station and the second base station have different TACs; based on at least determining that the first base station and the second base station have different TACs, transmit, by the first base station, to the UE, a first handover command with a SIB1 message for the second base station, the SIB1 message for the second base station containing the second TAC; determine that a second handover from the second base station to a third base station is pending by for the UE, wherein the third base station has the second TAC; determine that the second base station and the third base station have a common TAC; and based on at least determining that the second base station and the third base station have a common TAC, transmit, by the second base station, to the UE, a second handover command and not transmit, by the second base station, to the UE, a SIB1 message for the third base station.

An example method of wireless communication comprises: determining, by a wireless network, that a first handover from a first base station to a second base station is pending for a UE, wherein the first base station has a first TAC and the second base station has a second TAC that is different than the first TAC; determining that the first base station and the second base station have different TACs; based on at least determining that the first base station and the second base station have different TACs, transmitting, by the first base station, to the UE, a first handover command with an SIB1 message for the second base station, the SIB1 message for the second base station containing the second TAC; determining that a second handover from the second base station to a third base station is pending by for the UE, wherein the third base station has the second TAC; determining that the second base station and the third base station have a common TAC; and based on at least determining that the second base station and the third base station have a common TAC, transmitting, by the second base station, to the UE, a second handover command and not transmitting, by the second base station, to the UE, a SIB1 message for the third base station.

One or more example computer storage devices has computer-executable instructions stored thereon, which, upon execution by a computer, cause the computer to perform operations comprising: determining, by a wireless network, that a first handover from a first base station to a second base station is pending for a UE, wherein the first base station has a first TAC and the second base station has a second TAC that is different than the first TAC; determining that the first base station and the second base station have different TACs; based on at least determining that the first base station and the second base station have different TACs, transmitting, by the first base station, to the UE, a first handover command with an SIB1 message for the second base station, the SIB1 message for the second base station containing the second TAC; determining that a second handover from the second base station to a third base station is pending by for the UE, wherein the third base station has the second TAC; determining that the second base station and the third base station have a common TAC; and based on at least determining that the second base station and the third base station have a common TAC, transmitting, by the second base station, to the UE, a second handover command and not transmitting, by the second base station, to the UE, a SIB1 message for the third base station.

Alternatively, or in addition to the other examples described herein, examples include any combination of the following:
querying, by the first base station, the second base station, for a TAC of the second base station;
querying, by the second base station, the third base station, for a TAC of the third base station;
the first base station determines that the first base station and the second base station have different TACs;
the second base station determines that the second base station and the third base station have a common TAC;
while the UE is being served by the second base station, performing, by the UE, an MRU or a TAU with the wireless network, the MRU or TAU registering the UE with the second TAC;
while the UE is being served by the third base station, not performing, by the UE, an MRU or a TAU with the wireless network;
while the UE is being served by the third base station, paging, by the wireless network, the UE using the second TAC;
receiving, by the UE, the paging from the wireless network through the third base station;
the wireless network comprises a 5G cellular network;
the first base station comprises a gNB;
the second base station comprises a gNB;
the third base station comprises a gNB;
the first handover command and the second handover command each comprises an RRC reconfiguration message;
generating, by a control plane of the wireless network, the SIB1 message for the second base station;
the first base station or the control plane of the wireless network determines that the first handover is pending;
querying, by the first base station, the control plane of the wireless network, for a TAC of the second base station;
the SIB1 message for the second base station is within the first handover command;
based on at least completing the first handover, transmitting, by the UE, to the second base station a first RRC reconfiguration complete message;
the second base station or the control plane of the wireless network determines that the second handover is pending;
querying, by the second base station, the control plane of the wireless network, for a TAC of the third base station;
the second base station does not transmit the SIB1 message for the third base station; and
based on at least completing the second handover, transmitting, by the UE, to the third base station a second RRC reconfiguration complete message.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure. It will be understood that the benefits and advantages described above may relate to one embodiment or may relate to several embodiments. When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.”

Having described aspects of the disclosure in detail, it will be apparent that modifications and variations are possible without departing from the scope of aspects of the disclosure as defined in the appended claims. As various changes may be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A method of wireless communication, the method comprising:
determining, by a wireless network, that a first handover from a first base station to a second base station is pending for a user equipment (UE), wherein the first base station has a first tracking area code (TAC) and the second base station has a second TAC that is different than the first TAC;
determining that the first base station and the second base station have different TACs;
based on at least determining that the first base station and the second base station have different TACs, transmitting, by the first base station, to the UE, a first handover command with a system information block 1 (SIB1) message for the second base station, the SIB1 message for the second base station containing the second TAC;
determining that a second handover from the second base station to a third base station is pending by for the UE, wherein the third base station has the second TAC;
determining that the second base station and the third base station have a common TAC; and
based on at least determining that the second base station and the third base station have a common TAC, transmitting, by the second base station, to the UE, a second handover command and not transmitting, by the second base station, to the UE, a SIB1 message for the third base station.

2. The method of claim 1, further comprising:
querying, by the first base station, the second base station, for a current TAC of the second base station; and
querying, by the second base station, the third base station, for a current TAC of the third base station.

3. The method of claim 1,
wherein the first base station determines that the first base station and the second base station have different TACs; and
wherein the second base station determines that the second base station and the third base station have a common TAC.

4. The method of claim 1, further comprising:
performing, by the UE, a mobility registration update (MRU) or a TAC update (TAU) with the wireless network, the MRU or TAU registering the UE with the second TAC; and
while the UE is being served by the third base station, not performing, by the UE, any MRU or TAU with the wireless network.

5. The method of claim 4, further comprising:
while the UE is being served by the third base station, paging, by the wireless network, the UE using the second TAC; and
receiving, by the UE, the paging from the wireless network through the third base station.

6. The method of claim 1,
wherein the wireless network comprises a fifth generation (5G) cellular network;
wherein the first base station comprises a gNodeB (gNB);
wherein the second base station comprises a gNB;
wherein the third base station comprises a gNB; and
wherein the first handover command and the second handover command each comprises a radio resource control (RRC) reconfiguration message.

7. The method of claim 1, further comprising:
generating, by a control plane of the wireless network, the SIB1 message for the second base station.

8. A system comprising:
a processor; and
a computer-readable medium storing instructions that are operative upon execution by the processor to:
determine, by a wireless network, that a first handover from a first base station to a second base station is pending for a user equipment (UE), wherein the first base station has a first tracking area code (TAC) and the second base station has a second TAC that is different than the first TAC;
determine that the first base station and the second base station have different TACs;
based on at least determining that the first base station and the second base station have different TACs, transmit, by the first base station, to the UE, a first handover command with a system information block 1 (SIB1) message for the second base station, the SIB1 message for the second base station containing the second TAC;
determine that a second handover from the second base station to a third base station is pending by for the UE, wherein the third base station has the second TAC;
determine that the second base station and the third base station have a common TAC; and
based on at least determining that the second base station and the third base station have a common TAC, transmit, by the second base station, to the UE, a second handover command and not transmit, by the second base station, to the UE, a SIB1 message for the third base station.

9. The system of claim 8, wherein the operations are further operative to:
query, by the first base station, the second base station, for a current TAC of the second base station; and
query, by the second base station, the third base station, for a current TAC of the third base station.

10. The system of claim 8,
wherein the first base station determines that the first base station and the second base station have different TACs; and
wherein the second base station determines that the second base station and the third base station have a common TAC.

11. The system of claim 8, wherein the operations are further operative to:
perform, by the UE, a mobility registration update (MRU) or a TAC update (TAU) with the wireless network, the MRU or TAU registering the UE with the second TAC; and
while the UE is being served by the third base station, not perform, by the UE, any MRU or TAU with the wireless network.

12. The system of claim 11, wherein the operations are further operative to:
while the UE is being served by the third base station, page, by the wireless network, the UE using the second TAC; and
receive, by the UE, the paging from the wireless network through the third base station.

13. The system of claim 8,
wherein the wireless network comprises a fifth generation (5G) cellular network;
wherein the first base station comprises a gNodeB (gNB);
wherein the second base station comprises a gNB;
wherein the third base station comprises a gNB; and
wherein the first handover command and the second handover command each comprises a radio resource control (RRC) reconfiguration message.

14. The system of claim 8, wherein the operations are further operative to:
generate, by a control plane of the wireless network, the SIB1 message for the second base station.

15. One or more computer storage devices having computer-executable instructions stored thereon, which, upon execution by a computer, cause the computer to perform operations comprising:
determining, by a wireless network, that a first handover from a first base station to a second base station is pending for a user equipment (UE), wherein the first base station has a first tracking area code (TAC) and the second base station has a second TAC that is different than the first TAC;
determining that the first base station and the second base station have different TACs;
based on at least determining that the first base station and the second base station have different TACs, transmitting, by the first base station, to the UE, a first handover command with a system information block 1 (SIB1) message for the second base station, the SIB1 message for the second base station containing the second TAC;
determining that a second handover from the second base station to a third base station is pending by for the UE, wherein the third base station has the second TAC;
determining that the second base station and the third base station have a common TAC; and
based on at least determining that the second base station and the third base station have a common TAC, transmitting, by the second base station, to the UE, a second handover command and not transmitting, by the second base station, to the UE, a SIB1 message for the third base station.

16. The one or more computer storage devices of claim 15, wherein the operations further comprise:
querying, by the first base station, the second base station, for a TAC of the second base station; and
querying, by the second base station, the third base station, for a TAC of the third base station.

17. The one or more computer storage devices of claim 15,
wherein the first base station determines that the first base station and the second base station have different TACs; and
wherein the second base station determines that the second base station and the third base station have a common TAC.

18. The one or more computer storage devices of claim 15, wherein the operations further comprise:
performing, by the UE, a mobility registration update (MRU) or a TAC update (TAU) with the wireless network, the MRU or TAU registering the UE with the second TAC; and
while the UE is being served by the third base station, not performing, by the UE, any MRU or TAU with the wireless network.

19. The one or more computer storage devices of claim 18, wherein the operations further comprise:
while the UE is being served by the third base station, paging, by the wireless network, the UE using the second TAC; and
receiving, by the UE, the paging from the wireless network through the third base station.

20. The one or more computer storage devices of claim 15,
wherein the wireless network comprises a fifth generation (5G) cellular network;
wherein the first base station comprises a gNodeB (gNB);
wherein the second base station comprises a gNB;
wherein the third base station comprises a gNB; and
wherein the first handover command and the second handover command each comprises a radio resource control (RRC) reconfiguration message.
